(19) United States
(12) Patent Application Publication
(10) Pub. No.: US 2016/0091617 A1
(43) Pub. Date: Mar. 31, 2016

(54) PHOTON DETECTION APPARATUS AND ASSOCIATED METHODOLOGY TO ENABLE HIGH SPEED OPERATION

(71) Applicant: Umm Al-Qura University, Makkah (SA)

(72) Inventors: Abdessattar Salah Mohamed BOUZID, Makkah (SA); Kamel Mohamed Al-Aiech Guedri, Makkah (SA); Ahmed M. Nahhas, Makkah (SA)

(73) Assignee: Umm Al-Qura University, Makkah (SA)

(21) Appl. No.: 14/498,628

(22) Filed: Sep. 26, 2014

(51) Int. Cl. G01T 1/24

(52) U.S. Cl. CPC G01T 1/248; G01T 1/244

(57) ABSTRACT

A photon detection apparatus that includes a photon detector configured to detect single photons. The apparatus includes: a time-to-voltage converter circuit generating a signal proportional to the time interval the photon detector exceeds a reference threshold. Thus, it is the length of time the photon detector exceeds the threshold rather than integrated signal from the photon detector that indicates whether a photon is detected. A second threshold test then discriminates detection events based on the output signal from the time-to-voltage converter.

### BACKGROUND

### Description of the Related Art

Single-photon detection technologies provide the ultimate sensitivity for detection of extremely weak optical signals over a broad spectral range. Single-photon detectors (SPDs) nowadays play a critical role in an increasing number of applications such as semiconductor device characterization, singlet oxygen detection, eye-safe ranging and timing, quantum dot characterization, non-destructive testing of VLSI circuits, fiber optic sensing, as well as photonic research in a wide range of disciplines.

Recently, the emergence of quantum cryptography, particularly for the deployment of quantum key distribution (QKD) fiber optic systems, has generated interest in high speed single-photon detection at telecommunications wavelengths.

InGaAs/InP avalanche photodiodes (APDs) have proven a practical choice at telecommunication wavelengths due to their compact size, low cost, lower operating voltages, and the maturity of semiconductor material and process technologies.

In order to obtain extremely high gain for single-photon sensitivity, APDs are usually operated above the breakdown voltage in the so-called Geiger mode. The photons absorbed by the semiconductor material generate free carriers (electrons or holes) that will be multiplied by the process of impact ionization under high electric field, resulting in a detectable macroscopic current flow.

However, APDs usually contain crystallographic defects that act as traps and confine carriers from the macroscopic current flowing through the device during an avalanche event. Fractions of these trapped carriers are subsequently spontaneously released, and may result in the triggering of spurious avalanches in subsequent gates. Such spurious avalanches are called afterpulses.

To reduce the rate of these afterpulses, InGaAs/InP APDs can be operated in a gated mode, in which the gate duration is generally set to a few nanoseconds, and the time interval between adjoining gates on signal is chosen to be greater than the lifetime of the trapped carriers. Therefore, the repetition frequency and maximum count rate of InGaAs/InP APDs are severely limited. Thus, conventional configurations of InGaAs/InP APDs have been unsuitable for applications requiring high speed single-photon detection, such as the next generation high bit rate QKD systems.

### SUMMARY

An apparatus for detecting single photons including a photon detector that signals the absorption of a photon by changing a first output signal, and a time-to-voltage converter that generates a second output signal proportional to a high-signal time interval, wherein the high-signal time interval is the time duration that the first output signal is greater than a first reference signal. The apparatus also includes a discriminator that discriminates if the second output signal is greater than a second reference signal.

### BRIEF DESCRIPTION OF THE DRAWINGS

A more complete understanding of this disclosure is provided by reference to the following detailed description when considered in connection with the accompanying drawings, wherein:

FIG. 1 is a schematic diagram of an implementation of a photon detection apparatus, according to one example;

FIG. 2A is a plot of an implementation of a gate signal periodically modulating a DC bias above a break down voltage, according to one example;

FIG. 2B is a plot of an implementation of an output signal of a bias modulated APD photon detection apparatus, according to one example;

FIG. 3 is a circuit schematic of an implementation of a time-to-voltage converter and discriminator circuit, according to one example; and

FIG. 4 is the timing diagram of an implementation of a time-to-voltage converter and discriminator circuit, according to one example;

FIG. 5 is a circuit schematic of an implementation of a time-to-voltage converter circuit, according to one example;

FIG. 6 is a schematic of an implementation of a testing apparatus to test the photon detection apparatus;

FIG. 7 is a plot of the output of the testing apparatus as a function of the laser pulse delay; and

FIG. 8 is a plot of the dark count probability as a function of the quantum efficiency of the photon detection apparatus; and

FIG. 9 is a plot of the afterpulse probability as a function of the quantum efficiency of the photon detection apparatus.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be through and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and it is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although, conventional methods of afterpulse suppression for InGaAs/InP APDs are unsuitable for applications requiring high speed single-photon detection, such as the next generation high bit rate QKD systems, the advent of high-accuracy charge pulse compensation circuits has enabled a new class of single-photon detection capable of reaching high speeds.

In conventional single-photon detection systems, the time interval between two consecutive gate pulses is set to more than the lifetime of the trapped carriers (few microseconds) in order to reduce the afterpulse noise of the detector limiting gate repetition rates to less than 10 MHz. An alternative method of suppressing the afterpulse noise is to limit the avalanche charges by detecting weak avalanche signals. Unfortunately, weak avalanches are often buried within the APD capacitive response, especially when operating the APD at high speed.

Although weak avalanche signals can be discriminated by compensating the background signal from the APD capacitive response—e.g., by interfering the photon detector signal with itself in a Mach-Zehnder interferometer to cancel out periodic noise components, as discussed in U.S. patent application Ser. No. 10/011,1305 incorporated herein by reference in its entirety, (conventionally referred to as the self-differencing technique), or by modulating a DC bias voltage 103 periodically above the breakdown voltage and filtering the APD output with a band-stop filter to block the modulation frequency, as discussed in U.S. patent application Ser. No. 09/003,9237 incorporated herein by reference in its entirety, (conventionally referred to as sine-wave-gating with filtering)—the disadvantage of these methods is that they operate at fixed frequencies and are not continuously adjusted. Additionally, they require complicated electronics that are challenging to implement in practical applications. Thus, although these techniques compensate the APD capacitive response to the applied gate signal, they create other problems including: errors caused by two successive avalanches, difficulties with tuning the gate frequency continuously over a wide range for the self-differencing technique, and the variation of the effective gate-width with the frequency for the sine-wave-gating technique.

In contrast to the self-differencing and sine-wave-gating techniques, the single-photon detector described herein exhibits the ability to discriminate weak avalanche signals with high accuracy while operating at a high speed. The single-photon detector described herein includes an avalanche photodiode (APD) configured to detect single photons. The single-photon detector is biased using a DC bias signal 103 not exceeding breakdown voltage V_{BR} applied to the APD cathode, a bias modulation signal superimposed on the DC bias signal 103 such that the combination of DC and modulated bias signals periodically exceeds the APD breakdown voltage. The single-photon detector also includes a time-to-voltage converter circuit 106 generating a signal proportional to the total time during the measurement period for which the APD output exceeds a reference signal.

According to the single photon detector as structured above, the afterpulse noise can be sharply reduced comparing to conventional single photon detectors by minimizing the avalanche current and discriminating weak avalanche signals. The time interval that the APD output exceeds a reference signal rather than the peak voltage of the APD output indicates whether the photon detection event has occurred.

As the present invention enhances the sensitivity of the detector to detect avalanche signals arising from photo-electrons without increasing the bias voltage across the APD and the related increase in noise and dark counts, the detector described herein can operate at higher repetition rate than conventional detectors.

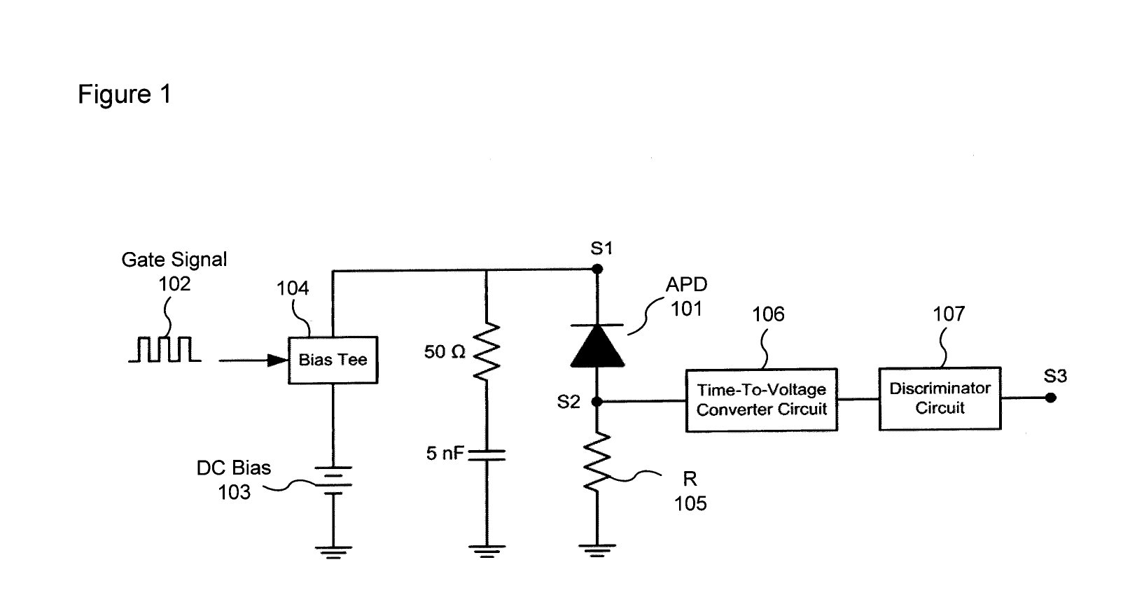

Referring now to the drawings, wherein like reference numerals designate identical or corresponding parts throughout the several views, FIG. 1 is a schematic diagram of a single-photon detection system according to one embodiment of the present invention. In FIG. 1, an avalanche photodiode (APD) 101 can be an InGaAs/InP APD. A gate signal 102 is a periodic series of rectangular voltage pulses. The DC bias voltage 103 is a reverse bias voltage below the breakdown voltage (V_{BR}) of the APD 101.

Using a Bias Tee 104 to superimpose the gate signal 102 and the DC bias voltage 103, the signal resulting from the Bias Tee 104 is the input signal S1 of the APD 101 and it exceeds V_{BR} of APD 101 during the gate-on time of the gate signal 102. When the signal S1 reverse biases the APD 101, the APD 101 exhibits intrinsic gain due to avalanching of the charge carriers in the multiplication region. In photo-detection, an absorbed photon generates an electron-hole pair in the sensitive area of APD 101. Then, due to the high electric field within the multiplication region of the APD 101, the generated electron-hole pair may trigger an avalanche causing a macroscopic current to flow through the APD 101. The APD output signal S2 can be measured by monitoring the voltage drop across the series resistor (R) 105.

The time-to-voltage converter circuit 106 compares the APD signal S2 to a first reference signal and generates an output signal proportional to the total time within the predefined period of the gate signal 102 that the signal S2 exceeds the first reference. The discriminator circuit 107 is used to compare the output signal of the time-to-voltage converter circuit 106 with a predetermined second reference voltage and determines whether or not a photon detection event occurs, thus generating a photon detection signal S3.

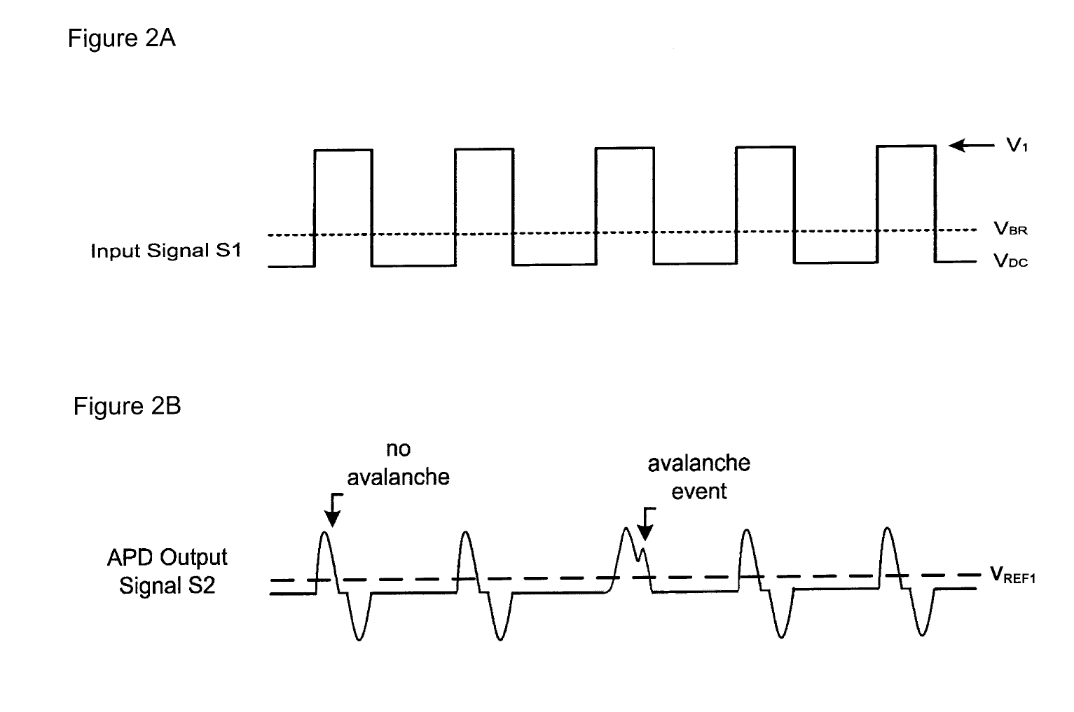

FIG. 2A is a schematic plot of the input signal S1 of the APD 101 as a function of time. The input signal S1 is a periodic series of rectangular voltage pulses which varies from a first value V_{DC} and a second value V₁. The voltage V_{DC} is selected to be below a breakdown voltage V_{BR} of the APD 101. The voltage V₁ is selected so as to exceed the breakdown voltage V_{BR} of the APD 101 during the gate-on time.

FIG. 2B is a schematic plot of the APD output signal S2 as a function of time. The APD output signal S2 in the absence of a photon detection event contains a charging pulse due to the charging of the APD 101 capacitance when reacting to the rise edge of the input signal S1, followed by a discharging dip due to the discharging of the APD 101 capacitance when reacting to the falling edge of the input signal S1. In the presence of a photon detection event, the avalanche signal is superimposed with a background capacitive response of the APD 101. As shown in FIG. 2B, when the avalanche signal is weak, it is difficult to isolate it from the background capacitive response.

Referring to FIG. 2B, the detection of a photon by the APD 101 (avalanche event) makes the high-signal time interval of the APD output signal S2 much bigger than in the case when there is no photon detection (no avalanche). The high-signal time interval is the total duration of time during the measurement period (i.e., one complete period of the input signal S1) that the signal S2 exceeds the first reference signal V_{REF1}. This high-signal time interval difference may be used to discriminate the photon detection event even in the case when the avalanche signal is weak, without any need to compensate the additional background noise resulting from the internal parasitic capacitance of the p-n junction of the APD 101.

Hereinafter, a description will be given of how photon detection discrimination can be made using the high-signal time interval of the APD 101 output signal according to one embodiment of the present invention.

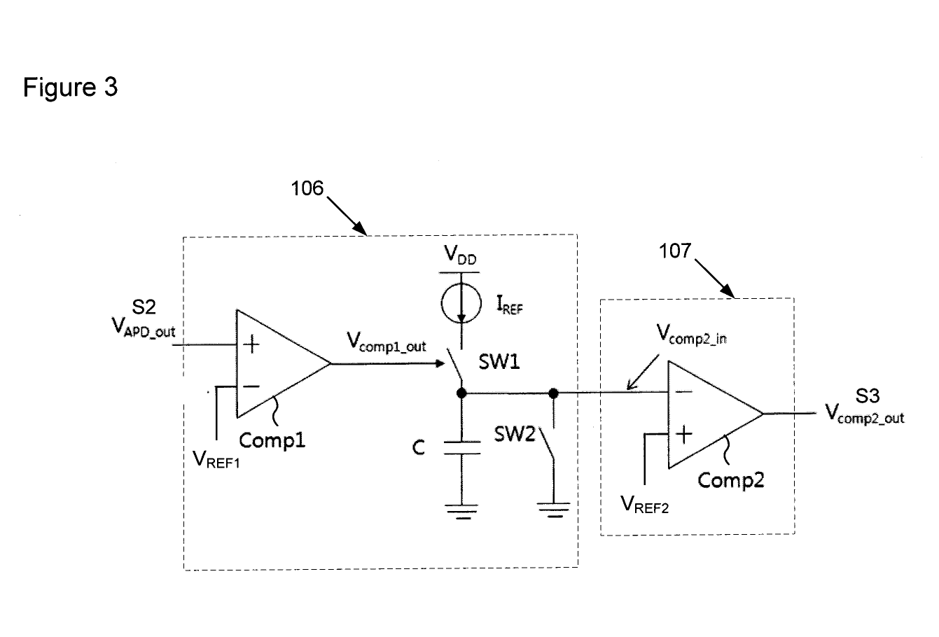

FIG. 3 shows a schematic configuration of the time-to-voltage converter circuit 106 and the discriminator circuit 107 of FIG. 1 according to one exemplary embodiment of the present invention. The first comparator Comp1 is used to compare the APD output signal V_{APD}_{_}ₒᵤₜ, which is also designated by signal S1, with a positive reference voltage V_{REF1}. Two normally open switches, SW1 and SW2, with a capacitor C, a voltage source V_{DD}, and a current source I_{REF} are used as a time-to-voltage converter circuit 106 which generates an output signal proportional to the high-signal time interval of its input signal. The second comparator Comp2 is used as a discriminator 107 to discriminate the photon detection event.

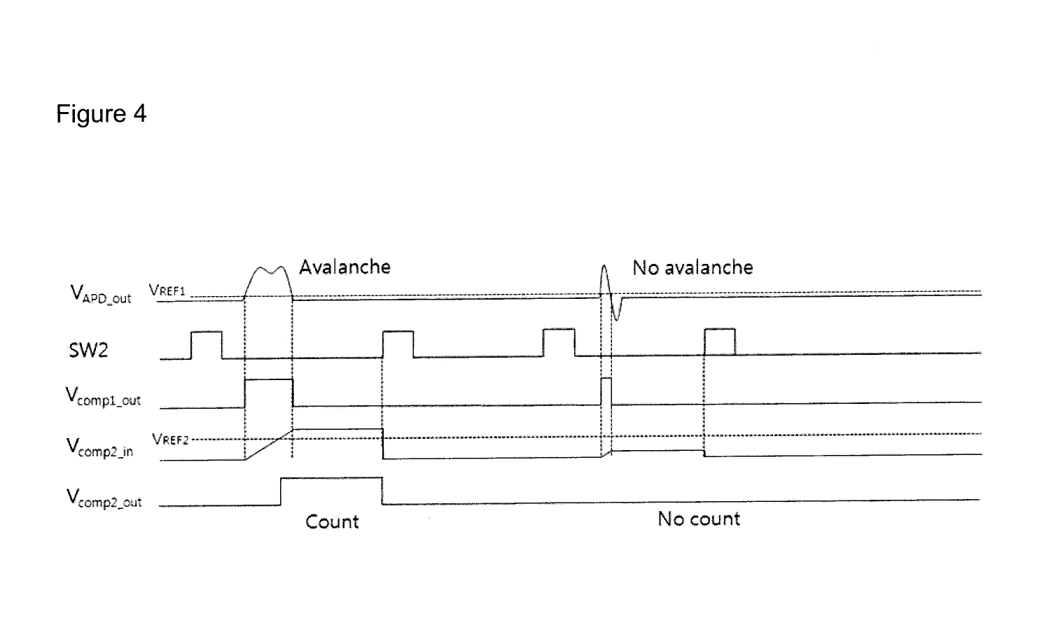

To better appreciate the schematic shown in FIG. 3 it is helpful to simultaneously reference the timing diagram in FIG. 4 showing of the signals to the Switch SW2; the Outputs V_{APD}_{_}ₒᵤₜ, V_{comp1}_{_}ₒᵤₜ, and V_{comp2}_{_}ₒᵤₜ; and input V_{comp2}_{_}ᵢₙ. FIG. 4 is the timing diagram of the time-to-voltage converter circuit 106 and the discriminator circuit 107 shown in FIG. 3. Both cases, no avalanche and avalanche, are shown in FIG. 4. The normally open switch SW2 is used to reset the time-to-voltage converter circuit 106 for the next detection by discharging the capacitor C. The reference voltage V_{REF1} is set slightly greater than zero volts. The first comparator Comp1 is used to compare the APD output voltage V_{APD}_{_}ₒᵤₜ with the reference voltage V_{REF1}, and while V_{comp1}_{_}ₒᵤₜ is high, the capacitor C integrates the current I_{REF} while generating a signal V_{comp2}_{_}ᵢₙ proportional to the time interval V_{APD}_{_}_{Out} exceeds V_{REF1}.

When V_{comp1}_{_}ₒᵤₜ is high the switch SW1 is closed causing current I_{REF} to flow into and charge the capacitor C, and when V_{comp1}_{_}ₒᵤₜ is low switch SW1 is open and no current flows. During each measurement period, there will always be at least a small time interval when V_{comp1}_{_}ₒᵤₜ is high due to the capacitive response of the APD 101 to the modulation of the bias current. However, the duration of time that V_{comp1}_{_}ₒᵤₜ is high is much greater when there is a photon detection event causing the APD 101 to avalanche as shown in FIG. 4. Therefore, detection events are indicated by the integrated current across the capacitor C, i.e. the voltage V_{comp2}_{_}ᵢₙ=∫I_{REF}dt/C, which is large when there is a detection event and small otherwise. In summary, the time between the rising edge and the falling edge of the APD output V_{APD}_{_}_{Out} is therefore represented as a voltage across the capacitor C. More specifically, the time-to-voltage converter circuit 106 generates across the capacitor C an output voltage V_{comp2}_{_}ᵢₙ proportional to the high-signal time interval of the APD output V_{APD}_{_}ₒᵤₜ.

As can be seen in FIG. 4, compared to the case of no avalanche, the high-signal time interval is larger in the case of an avalanche event and the voltage across the capacitor C V_{comp2}_{_}ᵢₙ is correspondingly larger than the no avalanche case. As shown in FIG. 4, a second reference voltage V_{REF2} is set to a voltage between the average of V_{comp2}_{_}ᵢₙ with an avalanche event and the average of V_{comp2}_{_}ᵢₙ without an avalanche event. By setting V_{REF2} between these two levels (i.e., averages of V_{comp2}_{_}ᵢₙ with and without a detection event), the comparator Comp2 discriminates between detection and no-detection events, and the resultant signal V_{comp2}_{_}ₒᵤₜ signals a high level when a photon is detected and signals a low level when no photon is detected. From this operation we can conclude that it is possible to discriminate the avalanche event without any compensation of the transient spikes.

In one implementation, the second reference voltage is adjustable. When feedback from detection events indicates that the number of false positive detection events is greater than a predefined tolerance, then the second reference voltage is adjusted upwards closer to the average value of V_{comp2}_{_}ᵢₙ with an avalanche/detection event. When feedback from detection events indicates that the number of missed detections is too great, then the second reference voltage is adjusted downwards closer to the average value of V_{comp2}_{_}ᵢₙ without an avalanche/detection event.

The second comparator Comp2 is used as a discriminator 107 to compare the input voltage of the comparator V_{comp2}_{_}ᵢₙ (which is equal to the voltage across the capacitor C) with the second reference voltage V_{REF2}. In one implementation, the second reference voltage V_{REF2} is set only slightly higher than the voltage across the capacitor C in the case when there is no avalanche event in order to minimize the number of missed detections. As can be seen in FIG. 4, by comparing the reference voltage V_{REF2} with the voltage across the capacitor C, V_{comp2}_{_}ᵢₙ, the comparator output V_{comp2}_{_}ₒᵤₜ is equal to one in the case of an avalanche event (count) and remains equal to zero in the case when there is no avalanche (no count).

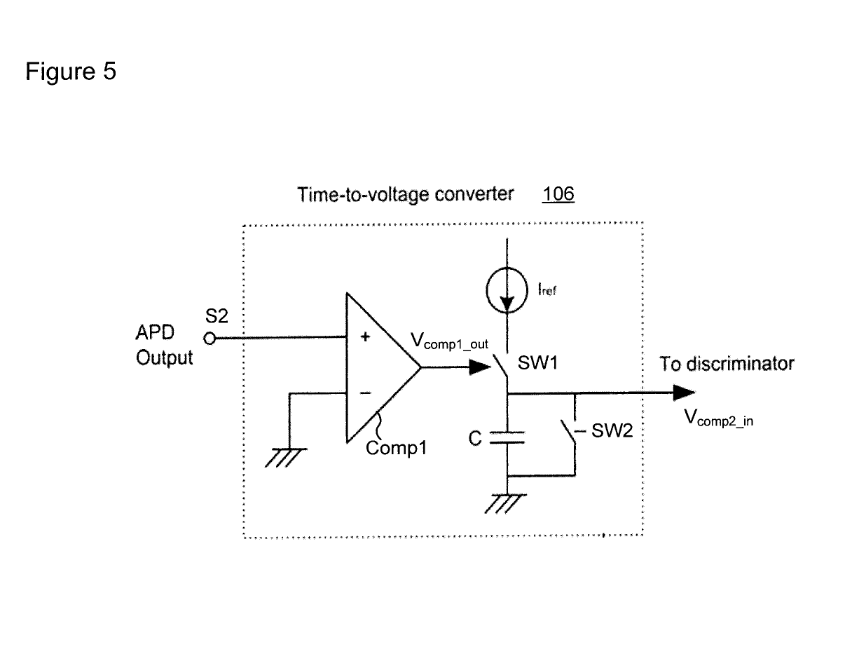

FIG. 5 shows one implementation of a time-to-voltage converter 106 used to measure the signal high time interval used in an experiment to demonstrate the advantages of the proposed single-photon detection apparatus. The time-to-voltage converter 106 consists of a current source I_{ref}, a comparator Comp1, a capacitor C, and two analog switches SW1 and SW2. While the signal V_{comp1}_{_}ₒᵤₜ is high the switch SW1 closes causing a current source I_{ref} to charge the capacitor C. When the signal to switch SW2 is high, as shown in FIG. 4, the switch SW2 will close causing the capacitor C to discharge resetting the circuit in preparation for the next measurement period.

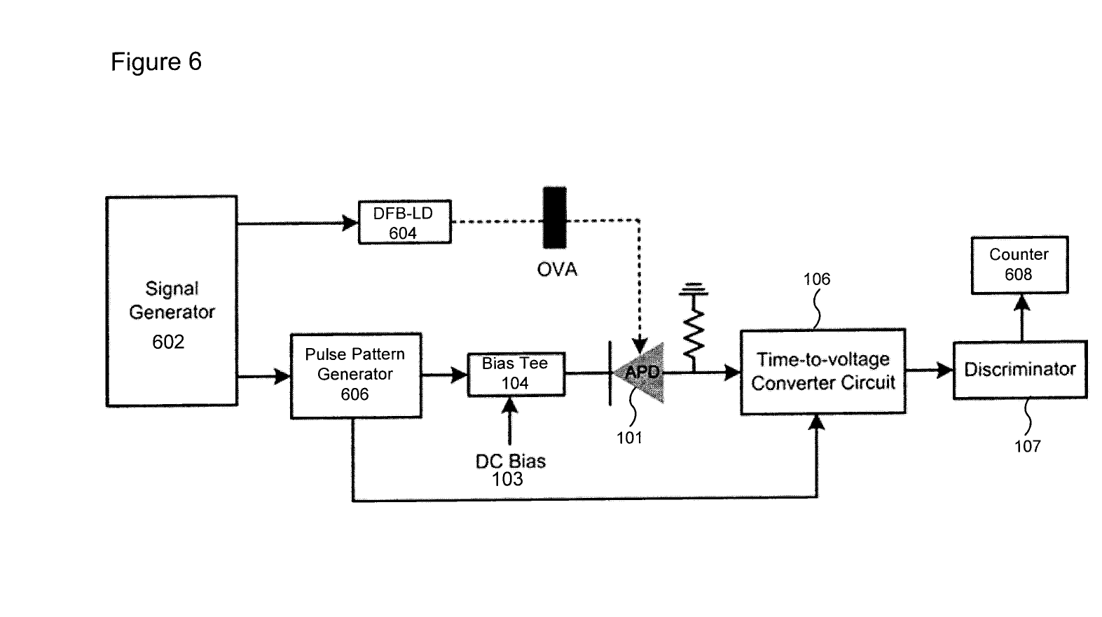

In one implementation, shown in FIG. 6, the single-photon detector includes that the APD 101 is an InGaAs/InP APD model number AGD-25-SE-1-T8 from Princeton Lightwave, Inc. Princeton Lightwave). The APD chip is mounted on a three-stage thermoelectric cooler (TEC), and they are together housed in a TO-8 can package. The APD 101 is cooled to −40° C. by the TEC driven by a proportional-integral-derivative (PID) controller. It is then fiber-pigtailed to be used as the single-photon detection element. A programmable signal generator 602 providing multiple frequencies acts as the time base of the system. The single-photon detector can be tested using a gain-switched distributed feedback laser diode (DFB-LD) 604 that is also triggered by the signal generator 602. The laser diode 604 can generate short coherent pulses at 1550 nm, with a pulse width of about 50 ps. These pulses can be attenuated to the single-photon level (0.1 photon/pulse) by an optical variable attenuator (OVA), and then sent for detection to the APD 101.

The signal generator 602 also provides a trigger signal for the single-photon detector. The trigger signal for the single-photon detector can be a pulse pattern generator 606 which produces rectangular pulses of 1 ns full width at half maximum (FWHM). By using a bias tee 104, the gate pulses from the pulse pattern generator 606 are superimposed on a DC bias voltage 103 to operate the APD 101 in gated Geiger mode. The time delay can be set so that the photons impinging on the APD's sensitive area were synchronized with the gate-on state. To sense the photon detection event, the high-signal time interval of the APD 101 output signal is processed by the time-to-voltage converter circuit 106 feeding into a discriminator circuit 107. For this implementation the time-to-voltage converter circuit 106 is shown in FIG. 5. The switches SW1 and SW2 are also controlled by the signal generator 602. The output of the discriminator 107 can be analyzed by post-processing circuitry and information about detection events recorded on a computer readable medium.

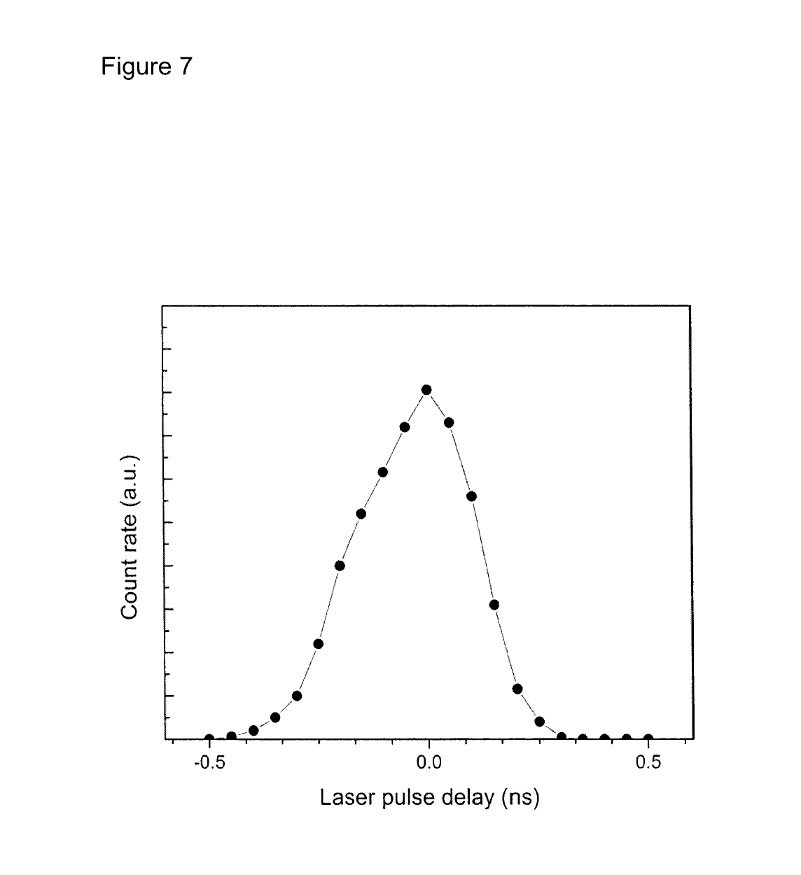

The implementation using the InGaAs/InP APD model number AGD-25-SE-1-T8 from Princeton Lightwave, Inc. was tested and verified to produce good results using the configuration shown in FIG. 6. This implementation was tested by changing the temporal delay between the laser pulse initiated by the signal generator 602 and the gate pulse signal initiated by the pulse pattern generator 608. The DC bias voltage 103 on the APD 101 was set to 64 V and was adjusted accordingly for the measurement in the experiment. The gate pulse width was around 1 ns FWHM with amplitude of 2.5 V. Since the laser pulse width is 50 ps, much shorter than the 1 ns gate pulse width, the laser pulse worked as a probe to investigate the gate pulse duration. FIG. 7 shows the photon count rate as a function of the laser pulse delay. Photons are detected only when they arrive within the gate pulse duration defined by the applied gate pulses. Photons arriving between gate pulses are not detected by the discriminator circuit 107, leading to a drop on the photon count rate to the dark count rate level. The relationship between the count rate and the laser pulse delay exhibits the gating profile. As shown in FIG. 7, the FWHM of the photon detection peak is ˜500 ps, reflecting the effective width of the gate pulse. In one experiment, the data was measured at a fixed temperature of −40° C. to efficiently reduce the dark count noise of the detector, a gate repetition rate of 10 MHz, and an illuminated light intensity of 0.1 photon/pulse.

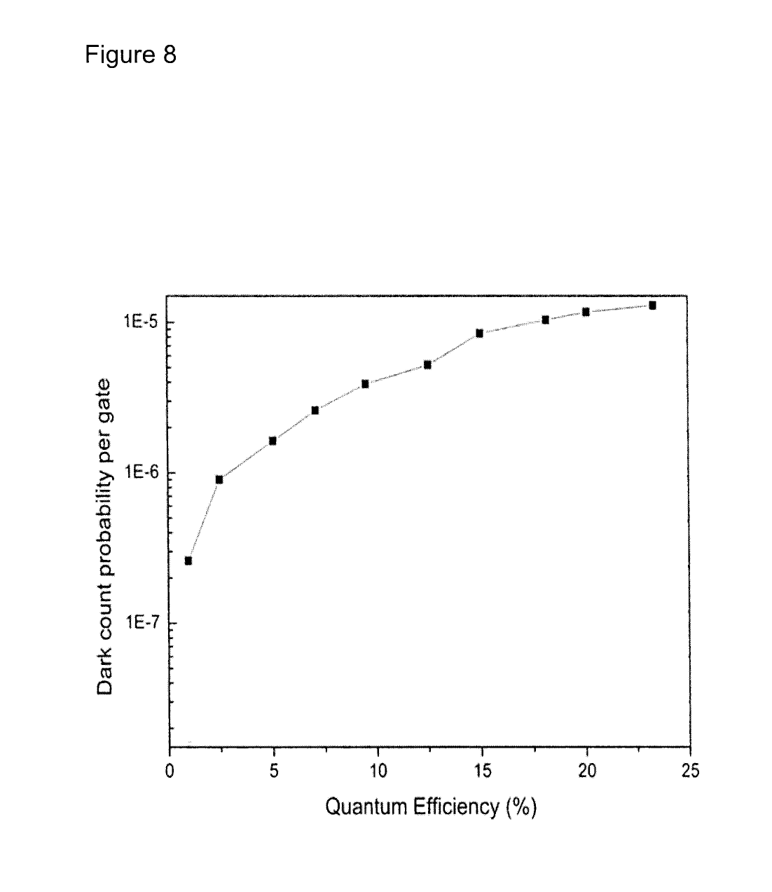

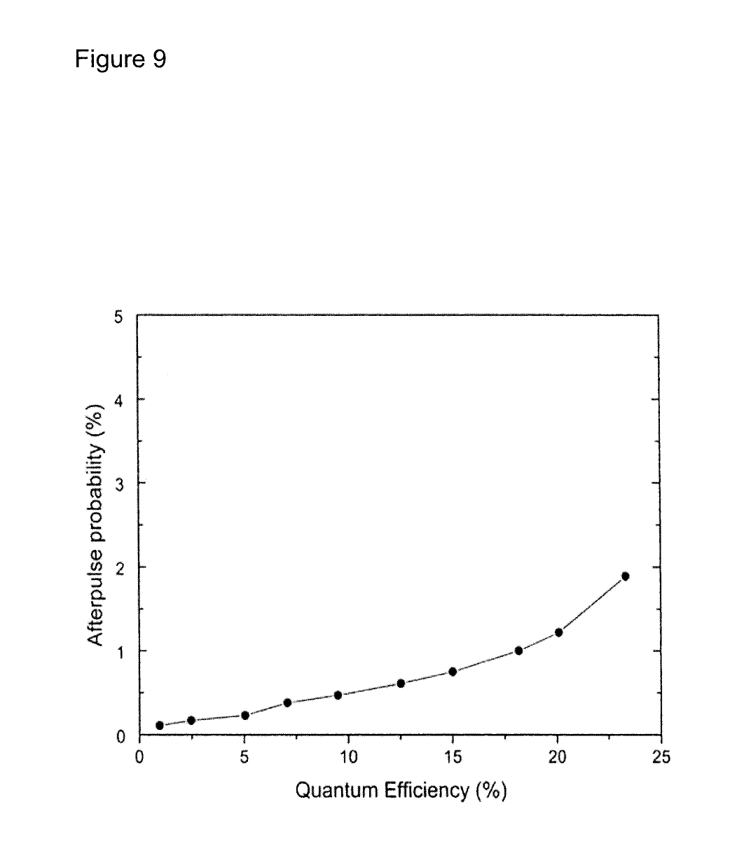

Also measured during the test were the dark count and afterpulse probabilities. The dark count and afterpulse probabilities were measured as a function of the quantum efficiency (η), by changing the DC bias voltage 103. As the single-photon pulses used in the experiment were provided by a coherent light source, photon number statistics was given by the Poisson distribution. Accordingly, the quantum efficiency n is calculated by

$$η = \frac{1}{μ} \times ln [ \frac{1 - {R}_{d c} / {f}_{g}}{1 - {R}_{d e}^{e} / {f}_{p}} ] ,$$

where, R_{dc} is the dark count rate and it was recorded under no light illuminations, R_{de}^{e} is the coincidence rate between the total recorded counts with the synchronous laser pulses, μ, is the mean photon number per laser pulse, f_{g} is the gate pulse repetition frequency and it is equal to 10 MHz, and fₚ is the laser pulse repetition frequency and it is equal to 100 kHz. Therefore, when there are many non-illuminated gates, the photon detection events occur only in the illuminated gates. Dark counts and afterpulses events occur in the non-illuminated gates. The dark count probability per gate signal (P_{dc}) is P_{dc}=R_{dc}/fg, neglecting the afterpulses of dark counts. The afterpulse probability per gate signal (Pₐₚ) can be calculated by

$${P}_{ap} = \frac{{R}_{de} - {R}_{de}^{c} - ( 1 - {f}_{l} / {f}_{g} ) {R}_{d c}}{{R}_{de}^{c}} ,$$

where R_{de} is the photon detection rate. As can be seen in FIG. 8 and FIG. 9, both the dark count and afterpulse probabilities increase with the quantum efficiency. However, the afterpulse probability was limited to a few percent even if the quantum efficiency was high. For example, the afterpulse probability per gate signal was as low as 1.22% with a detection efficiency of 20.1%. On the other hand, dark count probabilities per gate signal of 1.2×10₋₅ was achieved when the detection efficiency was equal to 20.1%. These experimental results demonstrate the effectiveness of the proposed method in reducing the afterpulse noise of the detector. The low afterpulse probability is attributed to the low excess bias voltage applied to the APD 101. The excess bias voltage is lowered in the time interval to voltage converter scheme to achieve the same quantum efficiency compared with conventional single-photon detector arrangements due to the capability of the proposed apparatus to discriminate weak avalanche signals.

It should be emphasized that, no compensation of the spike noise is required; resulting in ultra-high sensitive photon detection and many other advantages such as flexibility and compactness compared to conventional afterpulse suppression techniques which use complicated and sophisticated electronics to compensate the background signal of the APD output. The apparatus also allows the possibility of tuning the gate frequency continuously over a wide range of frequencies making the proposed apparatus easier to implement in practical and commercial single-photon avalanche photodiode applications.

In certain implementations, the signal generator 602 and the pulse pattern generator 606 are fully integrated with the time-to-voltage converter circuit 106 in a single electronic circuit that can be placed in close-proximity with the APD 101 to improve the integration level of our setup and provide high speed gating operation.

In one implementation, the timing circuitry controlling the switch SW2 and the bias signal modulation is adjustable. Also in one implementation, the voltage levels of the reference voltages V_{REF1} and V_{REF2} are adjustable. In one implementation, the voltage levels of the reference voltages V_{REF1} and V_{REF2} can be adjusted automatically based on measurement statistics and calibrations. The reference voltages V_{REF1} and V_{REF2} can be adjusted in order to satisfy a predetermined criterion, such as maintaining the number of dark counts below a predetermined level.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

1. An apparatus for detecting a photon comprising:
a photon detector signaling an absorption of the photon by outputting a first output;
a time-to-voltage converter that receives the first output and generates a second output that is proportional to a high-signal time interval that represents a width of a pulse of the first output, wherein the high-signal time interval is a time duration within a measurement time period during which the first output exceeds a first reference signal; and
a discriminator that receives the second output and signals that the photon is detected when the second output is greater than a second reference signal.

2. The apparatus according to claim 1, wherein the photon detector is an avalanche photodiode.

3. The apparatus according to claim 2, further comprising:
a bias modulator that modulates a bias signal, wherein the bias signal biases the photon detector during the measurement time period, the measurement time period having a low-time period and a high-time period, the modulated bias signal not exceeding a breakdown voltage of the photon detector during the low-time period, and the modulated bias signal exceeding the breakdown voltage of the photon detector during the high-time period.

4. The apparatus according to claim 3, wherein the bias modulator modulates the bias signal such that during the high-time period, the photon detector operates in a Geiger mode.

5. The apparatus according to claim 1, wherein the time-to-voltage converter includes a capacitor configured such that, during a detection time period within the measurement time period, the capacitor stores a charge that is proportional to the second output, and, during a reset time period after the detection time period and within the measurement time period, the charge on the capacitor is reset to an initial value.

6. The apparatus according to claim 5, further comprising:
a first switch and a second switch, wherein
during the detection time period, the second switch opens to prevent the capacitor from discharging and the first switch controls a flow of current into the capacitor charging the capacitor, and
during the reset time period, the first switch opens and the second switch closes to discharge the capacitor.

7. The apparatus according to claim 1, wherein the discriminator generates, during a detection time period within the measurement time period, a third output at a photon-detected level when the second output exceeds the second reference signal, and at a no-photon-detected level when the second output does not exceed the second reference signal.

8. The apparatus according to claim 1, wherein a level of the first reference signal and a level of the second reference signal are each adjustable.

9. The apparatus according to claim 8, wherein the second reference signal adjusts upwards when feedback of a rate a false positive detection events exceeds a predetermined threshold, and the second reference signal adjusts downwards when feedback of a percentage of missed detection events exceeds another predetermined threshold.

10. The apparatus according to claim 3, wherein the modulated bias signal includes a direct current component superimposed by a gate signal component.

11. The apparatus according to claim 10, wherein the gate signal is one of a square wave signal, a sine wave signal, and a bipolar gate signal.

12. The apparatus according to claim 10, wherein a period of the gate signal is adjustable.

13. The apparatus according to claim 1, wherein the photon detector is an InGaAs/InP avalanche photodiode configured to operate at telecommunications wavelengths between 1500 nm and 1600 nm.

14. The apparatus according to claim 13, wherein the photon detector is cooled by a thermoelectric cooler.

15. A method of detecting photons comprising:
signaling an absorption of a photon at a photon detector by changing outputting a first output;
receiving the first output at a time-to-voltage converter;
comparing, by the time-to-voltage converter, the first output to a first reference signal;
generating, by the time-to-voltage converter, a second output proportional to a high-signal time interval that represents a width of a pulse of the first output, wherein the high-signal time interval is a time duration within a measurement time period during which the first output exceeds a first reference;
receiving the second output at a discriminator; and
signaling, by the discriminator, that the photon is detected when the second output is greater than a second reference signal.

16. The method according to claim 15, wherein the photon detector is an avalanche photodiode.

17. The method according to claim 15, further comprising:
modulating a bias signal that biases the photon detector during the measurement time period having a low-time period and a high-time period, the modulated bias signal not exceeding a breakdown voltage of the photon detector during the low-time period and the modulated bias signal exceeding the breakdown voltage of the photon detector during the high-time period.

18. The method according to claim 15, wherein the comparing of the first output to the first reference signal further includes
charging a capacitor of the time-to-voltage converter, when the first output exceeds the first reference signal and the measurement time period is in the high-time period, and
discharging the capacitor of the time-to-voltage converter, when the measurement time period is in the low-time period.

19. The method according to claim 18, wherein the comparing of the first output to a first reference signal further includes
charging the capacitor of the time-to-voltage converter by closing a first switch, and
discharging the capacitor of the time-to-voltage converter by closing a second switch.
